(19) United States
(12) Patent Application Publication
(10) Pub. No.: US 2017/0238742 A1
(43) Pub. Date: Aug. 24, 2017

(54) StrawME

(71) Applicant: Rebecca T. Peterson, Glen Ridge, NJ (US)

(72) Inventor: Rebecca T. Peterson, Glen Ridge, NJ (US)

(21) Appl. No.: 15/050,034

(22) Filed: Feb. 22, 2016

(51) Int. Cl. A47G 21/18; A23L 27/00; A23P 10/10

(52) U.S. Cl. CPC A47G 21/183; A23P 10/10; A23L 27/70; A23V 2002/00

(57) ABSTRACT

The present invention relates to a single use tubular straw for conditioning of a liquid passing through including; a cylindrical body for passing of the liquid; a bottom opening for inflow of the liquid in the cylindrical body; a top opening for outflow of the liquid from the cylindrical body; at least one conditioning agent for the conditioning of the liquid passing through the cylindrical body; and a seal for closing the top opening and the bottom opening of the cylindrical body. The conditioning agent is disposed on the inner surface of the cylindrical body and get dissolved in the liquid on passing of the liquid through the cylindrical body providing the conditioned liquid at the top opening of the cylindrical body.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to a straw for drinking liquids. Particularly, the present invention relates to a liquid drinking straw made of biodegradable food grade material. More particularly, the present invention relates to single use biodegradable straw capable of conditioning the liquid passing through it.

(2) Background of the Invention

The use of flavored drinking straws is known in the prior art. More specifically, flavored drinking straws heretofore devised and utilized are known to consist basically of familiar, expected and obvious structural configurations, notwithstanding the myriad of designs encompassed by the crowded prior art which have been developed for the fulfillment of countless objectives and requirements.

Various flavored straw structure has been provided in the prior art to enhance consumption of fluid such as milk by individuals, particularly children. Such straw structure has typically utilized various manners of securing flavoring within the straw structure. Few examples sited in the prior art are as

U.S. Patent Publication U.S. 2004/0109932 (Jun. 10, 2004) provides a coated straw by melting the flavor ingredients and incorporating it into a solution consisting of a plasticizer, monoglyceride, and water. The solution is applied to the interior of the straw and dried to drive off water.

PCT WO 99/09871 to Schleider provides a drinking straw having a flavor-producing particulate coating on the outer surface. The coating contains a powdery granular flavor agent and a melt-able carrier resin, which is used to adhere the coating to the outer surface of the drinking straw.

Application WO 98/15187 discloses one such device. However, such straws may be unnecessarily complicated and too costly to produce, particularly in disposable form.

None of the above inventions and patents, taken either singly or in combination, are seen to disclose a single use tubular straw for the conditioning of a liquid passing through.

Further, none of this prior art suggests the present inventive combination of component elements arranged and configured for the efficient solution of this problem as disclosed and claimed herein. Prior devices do not provide the benefits of the present invention which achieves its intended purposes, objectives and advantages over the prior art devices through a new, useful and unobvious combination of component elements, through no increase in the number of functioning parts, at a minimum cost and through the utilization of only readily available materials and conventional components.

As such, it may be appreciated that there continues to be a need for a new and improved flavored drinking straw as set forth by the instant invention which addresses both the problems of ease of use as well as effectiveness in construction and in this respect, the present invention substantially fulfills this need.

### SUMMARY OF THE INVENTION

The present invention solves the problems of the prior art by providing a novel single use tubular straw for the conditioning of a liquid passing through.

The primary intent of the present invention is to provide a single use tubular straw for conditioning of a liquid passing through by utilizing the conditioning agent disposed on the inner surface of the straw.

An intent of the present invention is to provide a to a single use tubular straw for conditioning of a liquid passing through including; a cylindrical body for passing of the liquid; a bottom opening for inflow of the liquid in the cylindrical body; a top opening for outflow of the liquid from the cylindrical body; at least one conditioning agent for the conditioning of the liquid passing through the cylindrical body; and a seal for closing the top opening and the bottom opening of the cylindrical body.

Another intent of the present invention is to provide a single use tubular straw for conditioning of a liquid passing through made of biodegradable food grade material.

Another intent of the present invention is to provide a straw with a liquid conditioning agent for a liquid passing through.

Each intent of the present invention provides an advantage of a straw with a liquid conditioning agent for a liquid passing through.

Each intent of the present invention provides an advantage of the a straw made of biodegradable food grade material.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows a prospective view of a single use tubular straw for conditioning of a liquid passing through with sealed top and bottom openings; and

FIG. 2 shows a prospective view of a single use tubular straw for conditioning of a liquid passing through without seal.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

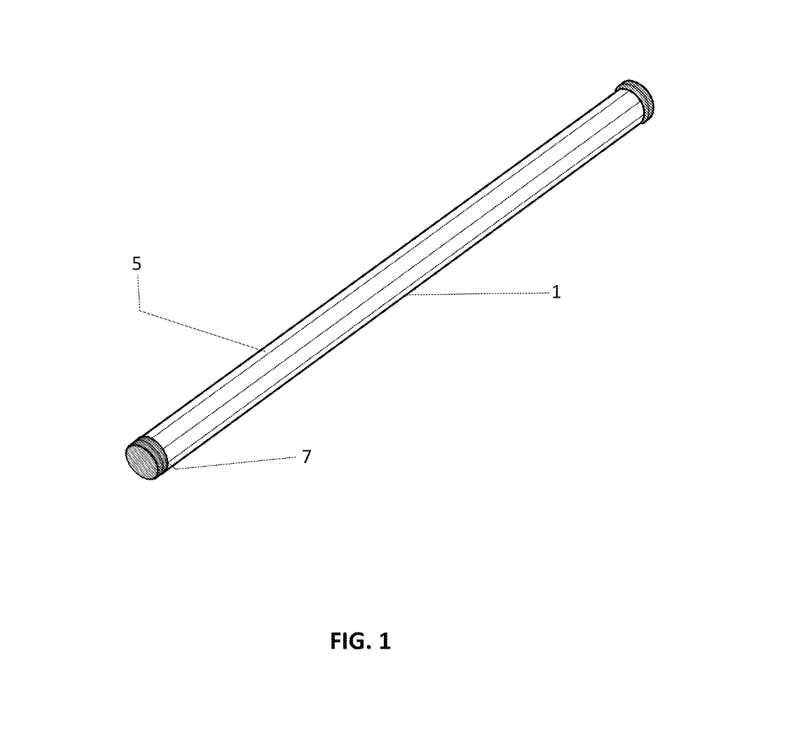

Referring now to the drawings, wherein like reference characters designate identical, or corresponding parts throughout the figures, and in particular FIGS. 1 & 2 show various embodiments of the single use tubular straw for conditioning of a liquid passing through in accordance with the present invention.

FIG. 1 shows a prospective view of a single use tubular straw for conditioning of a liquid passing through including a cylindrical body 01 with the outer surface 05 further including seals 07 for closing the cylindrical body 01. In this various embodiments of the present invention the cylindrical body 01 is made of biodegradable food grade material.

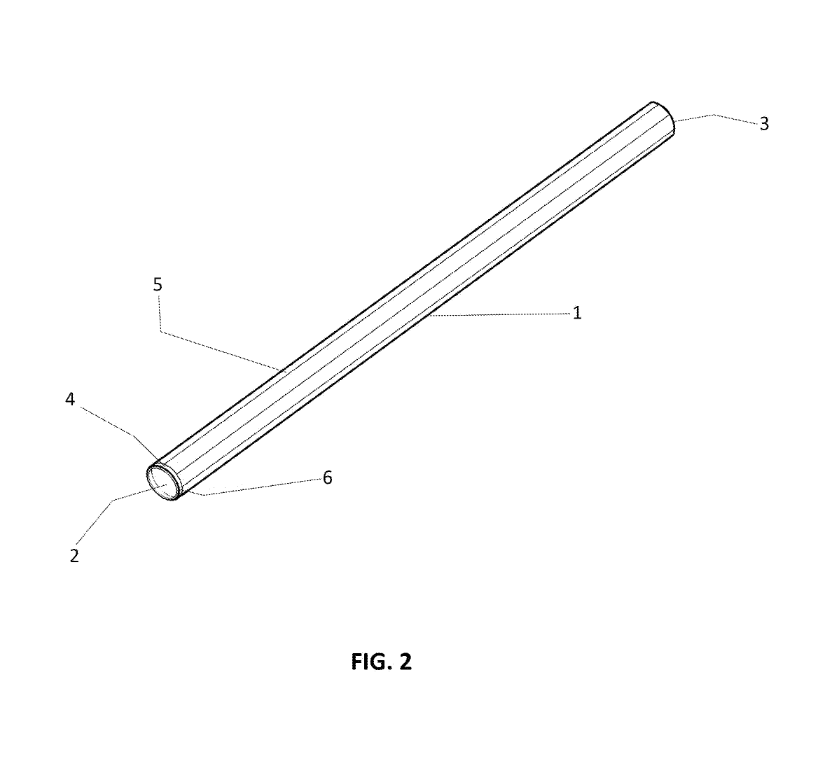

FIG. 2 shows a prospective view of a single use tubular straw for conditioning of a liquid passing through including the cylindrical body 01, the bottom opening 02, the top opening 03, the inner surface 04, the outer surface 05 and conditioning agent 06 disposed on the inner surface 04 of the cylindrical body 01.

In general present invention provides the single use tubular straw for conditioning of a liquid passing through including the cylindrical body 01, the bottom opening 02, the top opening 03, the inner surface 04, the outer surface 05, conditioning agent 06 disposed on the inner surface 04 of the cylindrical body 01 and seals 07 for closing the bottom opening 02 & top opening 03 of the cylindrical body 01.

In an embodiment the present invention provides the single use tubular straw for conditioning of a liquid passing through including the cylindrical body 01 made of biodegradable food grade material further including the bottom opening 02, the top opening 03, the inner surface 04, the outer surface 05, conditioning agent 06 disposed on the inner surface 04 of the cylindrical body 01 and seals 07 for closing the bottom opening 02 & top opening 03 of the cylindrical body 01.

In another embodiment the present invention provides the single use tubular straw for conditioning of a liquid passing through including the cylindrical body 01 made of biodegradable food grade material further including the bottom opening 02, the top opening 03, the inner surface 04, the outer surface 05, conditioning agent 06 disposed on the inner surface 04 of the cylindrical body 01 and seals 07 for closing the bottom opening 02 & top opening 03 of the cylindrical body 01. In this particular embodiment the conditioning agent 06 is energizing agent.

In a most preferred embodiment the present invention the single use tubular straw for conditioning of a liquid passing through including the cylindrical body 01 made of wax-coated food safe paper further including the bottom opening 02, the top opening 03, the inner surface 04, the outer surface 05, conditioning agent 06 disposed on the inner surface 04 of the cylindrical body 01 and seals 07 for closing the bottom opening 02 & top opening 03 of the cylindrical body 01. In this particular embodiment the conditioning agent 06 is flavoring agent. Also, seals 07 are made by pressing the bottom opening 02 & top opening 03 of the cylindrical body 01. In this particular embodiment dimension of the cylindrical body 01 is 8.5′×0.2875′×0.2875′.

It is to be understood that the above description is intended to be illustrative, and not restrictive. For example, the above-discussed embodiments may be used in combination with each other. Many other embodiments will be apparent to those of skill in the art upon reviewing the above description.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A single use tubular straw for conditioning of a liquid passing through comprising;
a) a cylindrical body for passing of said liquid further comprising an inner surface and an outer surface;
b) a bottom opening for inflow of said liquid in said cylindrical body;
c) a top opening for outflow of said liquid from said cylindrical body;
d) at least one conditioning agent for said conditioning of said liquid passing through said cylindrical body; and
e) a seal for closing said top opening and said bottom opening of said cylindrical body.

2. A single use tubular straw for flavoring of a liquid passing through according to claim 1, wherein said cylindrical body is made of biodegradable food grade material.

3. A single use tubular straw for flavoring of a liquid passing through according to claim 2, wherein said biodegradable food grade material is wax-coated food safe paper.

4. A single use tubular straw for flavoring of a liquid passing through according to claim 1, wherein said conditioning agent is selected from said group of flavoring agent, energizing agent or combination thereof.

5. A single use tubular straw for flavoring of a liquid passing through according to claim 1, wherein said conditioning agent is water soluble.

6. A single use tubular straw for flavoring of a liquid passing through according to claim 1, wherein said conditioning agent is disposed on said inner surface of said cylindrical body.

7. A single use tubular straw for flavoring of a liquid passing through according to claim 1, wherein said seal for closing said top opening and said bottom opening of said cylindrical body are removable.
